(19) United States
(12) Patent Application Publication
(10) Pub. No.: US 2024/0146899 A1
(43) Pub. Date: May 2, 2024

(54) METHOD AND APPARATUS FOR SYNCHRONIZING A PERIPHERAL DEVICE WITH DISPLAY IMAGE FRAMES

(71) Applicant: Athanos, Inc., Pomona, CA (US)

(72) Inventor: Peter Giokaris, Pomona, CA (US)

(21) Appl. No.: 18/496,500

(22) Filed: Oct. 27, 2023

Related U.S. Application Data
(60) Provisional application No. 63/421,664, filed on Nov. 2, 2022.

(51) Int. Cl. H04N 13/398; H04N 13/15; H04N 13/194; H04N 13/344

(52) U.S. Cl. CPC H04N 13/398; H04N 13/15; H04N 13/194; H04N 13/344; H04N 2013/0077

(57) ABSTRACT

Methods and apparatus for synchronizing a peripheral device with display images frames are disclosed. Image frame data for a sequence of display image frames is generated, the image frame data comprising color values for a plurality of display picture elements (pixels). Synchronization data is embedded in a predetermined set of pixels within the image frame data for each display image frame of the sequence of display image frames. The image frame data, including the synchronization data, is transmitted to a display device. The synchronization data is extracted from the image frame data. A synchronization signal is generated based on the extracted synchronization data. The peripheral device performs actions synchronized with the display image frames in response to the synchronization signal.

### RELATED APPLICATION INFORMATION

This patent claims priority from U.S. provisional patent application No. 63/421,664 entitled “METHOD FOR TRANSMITTING A TIGHTLY SYNCHRONIZED ENCODED SIGNAL THROUGH A DISPLAY DEVICE” filed Nov. 2, 2022, the entire content of which is incorporated herein by reference.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

### Field

This disclosure relates to synchronizing a device, separate from a display device, with display image frames by means of synchronizing data embedded in one or more pixels (picture elements) of each display image frame.

### Description of the Related Art

Current display devices present images as a sequence of image frames. Each image frame is comprised of a matrix of rows and columns of picture elements or “pixels”. Current display devices may present up to 500 sequential image frames per second. This rate continues to climb as technology advances. The number of image frames presented per second is commonly called the “frame rate” or “refresh rate” of the display device. Currently, each image frame may contain as many as 8.3 million color pixels. The number of pixels in an image frame will be referred to herein as the “resolution” of the display. For example, current “4 k” or UHD (ultra high definition) display devices present image frames with a resolution of 2160 rows of 3840 pixels. Future display devices may provide even higher resolution. Current display devices may also provide high contrast (i.e. wide separation between the brightness of “black” and “white” pixels), a wide color range or color gamut, and low latency or cross-talk between successive image frames. Current high performance computing devices have the capability of generating display image data consistent with the resolution and frame rate of these displays.

In this patent, the terms “image frame” and “display image frame” refer to the image actually presented on a display. The term “image data frame” refers to data defining an image frame. An image data frame commonly includes one byte (8 bits) of data for each of the red, green, and blue components of every pixel in the image frame. Other image data frame formats may be used. Image data frames are typically created by a computing device, transmitted from the computing device to a display device using an image data transmission protocol, and converted into an image frame by the display device.

Some applications of display devices require synchronization between display image frames and one or more peripheral devices. In this context, “peripheral device” means a device that is separate from both the display device and the computing device that generates the display content. For example, a stereographic image provides an illusion of depth by presenting different two-dimensional images to each of a viewer's eyes. Such stereographic images are commonly referred to as “3D” images although they lack the perspective of a truly three-dimensional scene. Stereographic images may be presented using a display device in conjunction with shutter glasses that can alternately occlude one or the other of the viewer's eyes. This action is sometimes described as “active shutter” meaning that it alternates the occlusion in an active fashion, so as to differentiate it from passive polarized lenses or different colored lenses (e.g. typical of 50s era 3D movies). Ideally, image frames intended for the observer's left and right eyes are presented alternately on the display device and the shutter glass occlude the viewer's eyes alternately in synchronization with the display image frames such that each eye only sees images frames intended for that eye.

The use of shutter glasses to present stereographic images is an example (which will be reused throughout this patent) of synchronizing a peripheral device (the shutter glasses) with display image frames. Other applications of shutter glasses synchronized with display image frames may include presenting different content, such as different video images or different game images, to two or more viewers via the same display device. Peripheral devices other than, or in addition to, shutter glasses may be synchronized with display image frames. Such peripheral devices may include sound effect generators, physical effects (such as motion of an object), haptics (such as seat motion or vibration, environment effects (such as wind or fog generators) and/or other devices that can be synchronized with a display presentation to enhance the viewer's experience.

Many, if not all, current computing devices do not have the capability of directly providing a synchronizing signal to a peripheral device to be synchronized with display image frames. Thus a technique, compatible with current computing and display devices, is needed for synchronizing a peripheral device with display image frames.

### DESCRIPTION OF THE DRAWINGS

FIG. 1 is aa block diagram of a system including a peripheral device synchronized with display image frames.

FIG. 2 is a plan view of a display image frame presented on a display device with synchronization data embedded in the display image frame.

FIG. 3 is a block diagram of an exemplary computing device.

FIG. 4 is a block diagram of another system including a peripheral device synchronized with display image frames.

FIG. 5 is a flowchart of a process for synchronizing a peripheral device with a display image frame.

FIG. 6 is a flowchart of another process for synchronizing a peripheral device with a display image frame.

Throughout this description, elements appearing in figures are assigned three-digit reference designators, where the most significant digit is the figure number where the element is introduced and the two least significant digits are specific to the element. An element that is not described in conjunction with a figure may be presumed to have the same characteristics and function as a previously-described element having the same reference designator.

### DETAILED DESCRIPTION

This patent is directed to apparatus and methods for synchronizing a peripheral device with display image frames by means of synchronization data embedded in a predetermined set of one or more pixels (picture elements) within some or all display image data frames.

Description of Apparatus

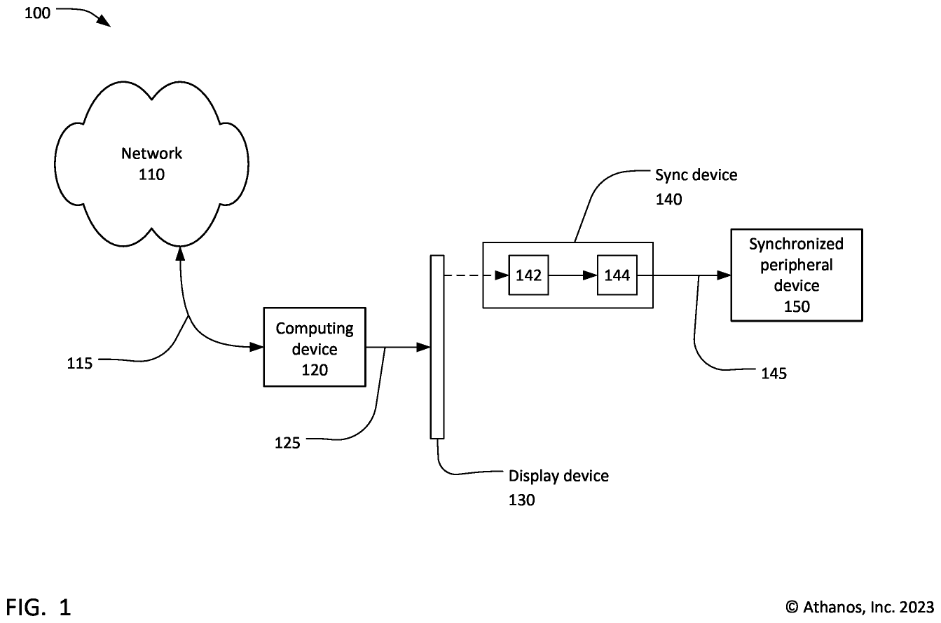

Referring now to FIG. 1, a system 100 includes a computing device 120, a display device 130, a sync device 140, and a synchronized peripheral device 150. The computing device 120 may typically, but not necessarily, be connected to a network 110.

The computing device 120 may be any device that includes a processor and memory and is capable of executing stored instructions. The computing device 120 may be, for example, a desktop, laptop, or tablet computer, a server, an internet appliance, a cellular telephone, a game console, or some other computing device. The computing device 120 generates display image data frames that are transmitted via communication link 125 to the display device 130 as a series of sequential image data frames. For example, the computing device 120 may execute application software to render sequential frames of display image data. The display image data for a frame being rendered may typically be stored is a portion of memory commonly called a “frame buffer.” Memory addresses within the frame buffer map to corresponding pixels with the display image frame. While rendering the display image data frame, the computing device 120 stores a color value for each pixel at the corresponding addresses within the frame buffer. Typically, each display pixel has red, green, and blue sub-pixels. The color value of each pixel is commonly represented by an eight-bit value for each of the three subpixels which allows nearly 17 million different color values for each pixel. When the complete image frame has been rendered, the image data frame is sent to the display device 130 and the computing device 120 begins rendering the next image frame. The computing device 120 may have multiple frame buffers available so an image frame can be rendered into one frame buffer while a second frame buffer is read and sent to the display.

Synchronization data is embedded within the image frame data of each display frame by writing one of a predetermined set of color values to memory addresses corresponding to a predetermined set of display pixels. The predetermined set of color values is selected from the possible range of color values. The predetermined set of color values may contain as few as two values (e.g. black and white) and typically will not contain more than ten color values. The predetermined set of pixels may be divided into two or more subsets or pixels, each of which may receive a different color value.

Synchronization data may be embedded within the display image data in the frame buffer after the rendering of a display image frame is complete by replacing the display image data for a predetermined pixel set with the synchronization data. Alternatively, the computing device 120 may generate the display image data and the synchronization data concurrently.

The computing device 120 may optionally be connected to a network 110, which may be or include the Internet, a wide area network, a local area network, a personal area network, cellular telephone network, a cable television distribution network, or some other network. The computing device 120 may communicate with the network via one or more standard or proprietary communications paths 115, which may be wired, wireless, fiber optic, or optical.

The computing device 120 sends display image data to the display device 130 via the communications link 125 in accordance with a standard or proprietary data transmission protocol. Presently, the most common protocol for transmitting display image data to a display device is the High Density Multimedia Interface (HMDI®). Other current or future wired, wireless, or optical data transmission protocols may be used.

The display device 130 may be any display device that is compatible with the data transmission protocol for the display image data and has the resolution, frame rate, and visual performance (i.e. contrast, brightness, color gamut, latency, etc.) required for the intended application.

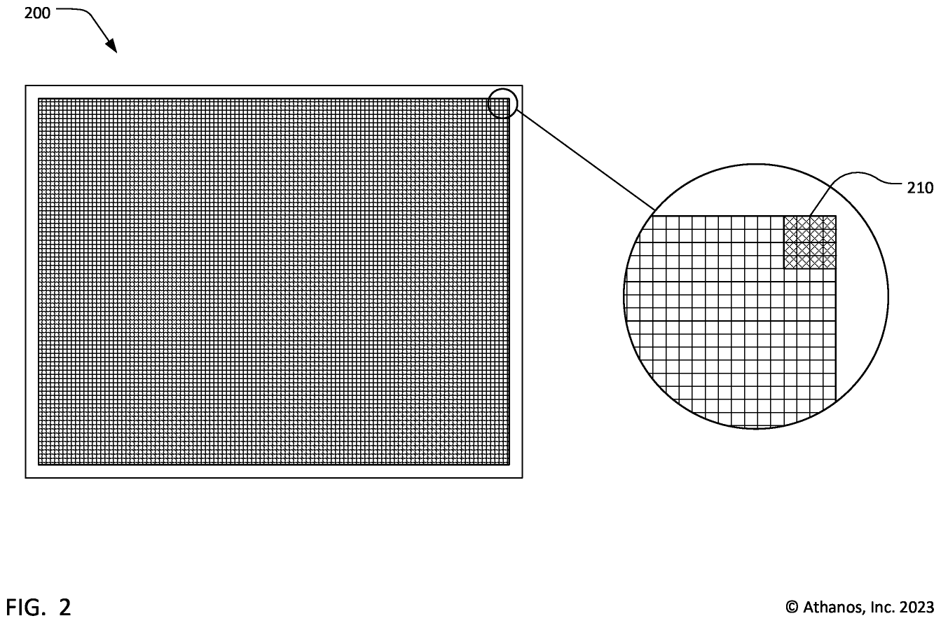

Refer now to FIG. 2, which shows an exemplary display image frame 200 presented on a display device such as the display device 130 of FIG. 1. The display image frame consists of a matrix of rows and columns of pixels. Synchronization data 210 is embedded within a predetermined set of pixels within the display image frame 200. In this example, the predetermined pixel set consists of a square 4×4 array of pixels (shown with cross-hatching) in the upper right-hand corner of the display image frame. A predetermined pixel set for synchronization data may have more or fewer than 16 total pixels, may have a shape other than a square array, and may be located in some other position with the display image frame.

The synchronization data is represented by the color value of the predetermined pixel set. Continuing the example of presenting stereographic images in conjunction with shutter glasses, the predetermined pixel set may be white to indicate the display image frame is intended for the viewer's right eye and the predetermined pixel set may be black to indicate the display image frame is intended for the viewer's left eye.

Synchronization data embedded in a display image frame is not limited to a binary (i.e. black/white left/right) value. In other applications, the predetermined pixel set may be a color selected from a color set with more than two values. Continuing the example of presenting stereographic images, a three-value color set might be used where red=occult the left eye, green=occult the right eye, and blue=occult both eyes.

Further, the predetermined pixel set may be divided into two or more subsets that independently convey different synchronization data. Expanding on the stereographic image example, assume two viewers are watching different stereographic images on the same display. A first pixel subset may indicate left eye or right eye, and a second pixel subset may indicate viewer 1 or viewer 2. The same result can be achieved with a single undivided pixel set and a choice of four color-values.

Referring back to FIG. 1, the sync device 140 extracts the synchronization data from the display image frames presented on the display and provides a synchronization signal or signals 145 to the synchronized peripheral device 150. The sync device 140 includes a data extractor 142 to read the synchronization data from the image frames presented on the display 120. To this end, the data extractor 142 includes one or more optical detectors to read the color of the predetermined pixel set within the display image frames. In the continuing example of presenting stereographic images, the data extractor may include a signal optical detector to determine if the predetermined pixel set is either black or white. In applications where the predetermined pixel set may have a color value selected from a color set with more than two values, the data extractor may include two or more detectors with respective color filters. In applications where the predetermined pixel set is divided into two or more subsets, the data extractor 142 may contain separate detector(s) for each subset. The data extractor 142 may also contain one or more optical elements, such as a lens, to form an image of the predetermined pixel set on the detector(s).

The sync device 140 also includes a synchronization signal generator 144 that generates synchronization signal(s) 145 based on the synchronization data extracted by the data extractor 142. The synchronization signal generator 144 contains logic circuitry to generate the synchronization signal(s) from the synchronization data. Where appropriate, the logic circuitry may be, or be part of, a microprocessor, a microcontroller, a field-programmable gate array, or some other form of digital circuitry.

The synchronization signal(s) 145 may be conveyed from the sync device 140 to the synchronized peripheral device 150 by a wired connection. The synchronization signal(s) 145 may be conveyed from the sync device 140 to the synchronized peripheral device 150 by a radio frequency (RF) wireless connection, in which case the synchronization signal generator 144 will include an RF transmitter. The synchronization signal(s) 145 may be conveyed from the sync device 140 to the synchronized peripheral device 150 by an optical connection, in which case the synchronization signal generator will include a light emitting diode or laser light source.

The sync device 140 0may be physically separate from the display device 130 or may be attached to the front surface of the display device 130. Alternatively, the sync device may be integrated into the display device.

The synchronized peripheral device may be shutter glasses and/or some other device as previously described.

Embedding the synchronization data in each video image frame guarantees the synchronization signal(s) 145 are precisely synchronized with the video frames. Since the synchronization data extracted optically from each displayed image frame, the sync device 140 is agnostic to the type of display 130 and to the data transmission protocol for the communication link 125.

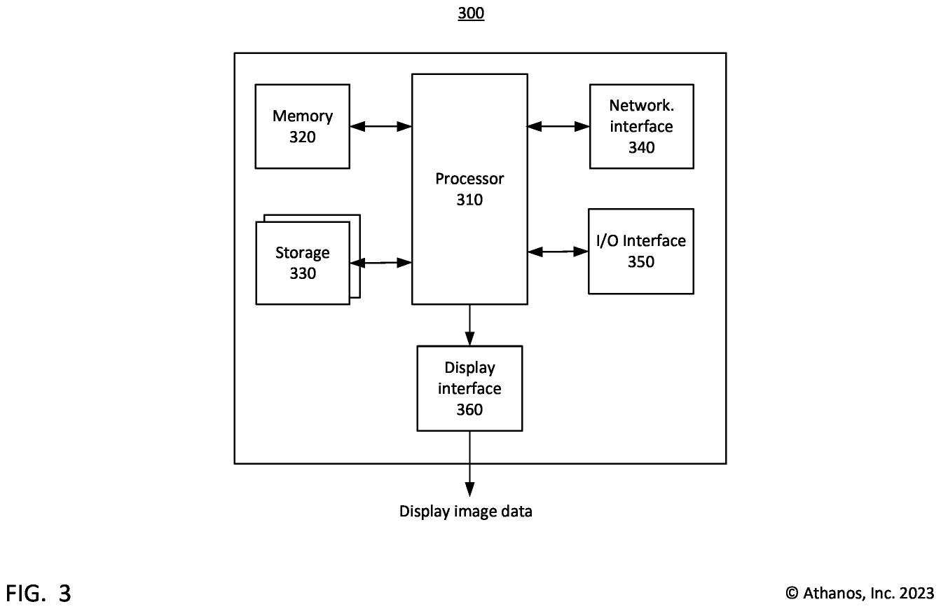

FIG. 3 is a block diagram of an exemplary computing device 300, which may be, or be a part of, the computing device 120 in system 100 of FIG. 1. A “computing device” as used herein refers to any device with a processor, memory and a storage device that may execute instructions including, but not limited to, personal computers, server computers, computing tablets, set top boxes, video game systems, personal video recorders, telephones, personal digital assistants (PDAs), portable computers, and laptop computers. The computing device 300 includes a processor 310, memory 320, storage 330, a network interface 340, an input/output interface 350, and a display interface 360. Some of these elements may or may not be present, depending on the implementation. Further, although these elements are shown independently of one another, each may, in some cases, be integrated into another.

The processor 310 may be or include one or more microprocessors, microcontrollers, digital signal processors, application specific integrated circuits (ASICs), or a systems-on-a-chip (SOCs). The processor may include a central processing unit (CPU) and a graphics processing unit (GPU). One or both of the CPU and the GPU may include multiple processing cores. Where present, the CPU and GPU may be implemented in a single integrated circuit chip or multiple integrated circuit chip which may be located on a common circuit board or separate circuit boards.

The memory 320 may include a combination of volatile and/or non-volatile memory including read-only memory (ROM), static, dynamic, and/or magnetoresistive random access memory (SRAM, DRM, MRAM, respectively), and nonvolatile writable memory such as flash memory. The memory 320 may store data and software instructions for execution by the processor. A portion of the memory 320 may be dedicated to store data and/or instructions for the CPU. A portion of the memory 320 may be dedicated to store data and/or instructions for the GPU. A portion of the memory may be shared by the CPU and GPU. The memory may include one or more frame buffers that store complete frames of display image data.

Storage 330 may store software programs and routines for execution by the processor. Portions of these software programs may be copied into the memory 320 during execution. These stored software programs may include an operating system software. The stored software programs may include an application or “app” to cause the computing device to perform portions of the processes and functions described herein. The operating system may include functions to support the input/output interface 350. The operating system may also include functions to support the network interface 340 such as protocol stacks, coding/decoding, compression/decompression, and encryption/decryption.

Storage 330 may be or include non-volatile memory such as hard disk drives, flash memory devices designed for long-term storage, writable media, and proprietary storage media, such as media designed for long-term storage of data. The storage 330 may include a machine readable storage media in a storage device included with or otherwise coupled or attached to a computing device 300. As used herein, a “storage device” is a device that allows for reading and/or writing to a storage medium. Software programs may be stored in electronic, machine-readable media. These storage media include, for example, magnetic media such as hard disks, optical media such as compact disks (CD-ROM and CD-RW) and digital versatile disks (DVD and DVD±RW), flash memory cards, and other storage media. The term “storage medium”, as used herein, explicitly excludes propagating waveforms and transitory signals.

The network interface 340 may be used to communicate with devices external to the computing device 300 via one or more networks. The network interface 340 may include a cellular telephone network interface, a wireless local area network (LAN) interface, a wireless personal area network (PAN) interface, and/or one or more wired network interface. A cellular telephone network interface may use one or more cellular data protocols. A wireless LAN interface may use the WiFi® wireless communication protocol or another wireless local area network protocol. A wireless PAN interface may use a limited-range wireless communication protocol such as Bluetooth®, Wi-Fi®, ZigBee®, or some other public or proprietary wireless personal area network protocol. The wired network interfaces may include one or more standard interfaces such as universal serial bus (USB) and Ethernet and/or one or more proprietary interfaces.

The network interface 340 may include radio-frequency circuits, analog circuits, digital circuits, one or more antennas, and other hardware, firmware, and software necessary for communicating with external devices. The network interface 340 may include one or more specialized processors to perform functions such as coding/decoding, compression/decompression, and encryption/decryption as necessary for communicating with external devices using selected communications protocols. The network interface 340 may rely on the processor 310 to perform some or all of these function in whole or in part.

The input/output interface 350 may include one or more input devices such as a touch screen, keypad, keyboard, stylus or other input devices.

The display interface 360 provides display image data frames to a display device (not shown). The display interface may provide the display image frame data using a standard protocol such as a High Density Multimedia Interface (HDMI). The display interface may provide the display image frame data to the display device using some other current or future standard or proprietary protocol which may be wired, wireless, or optical.

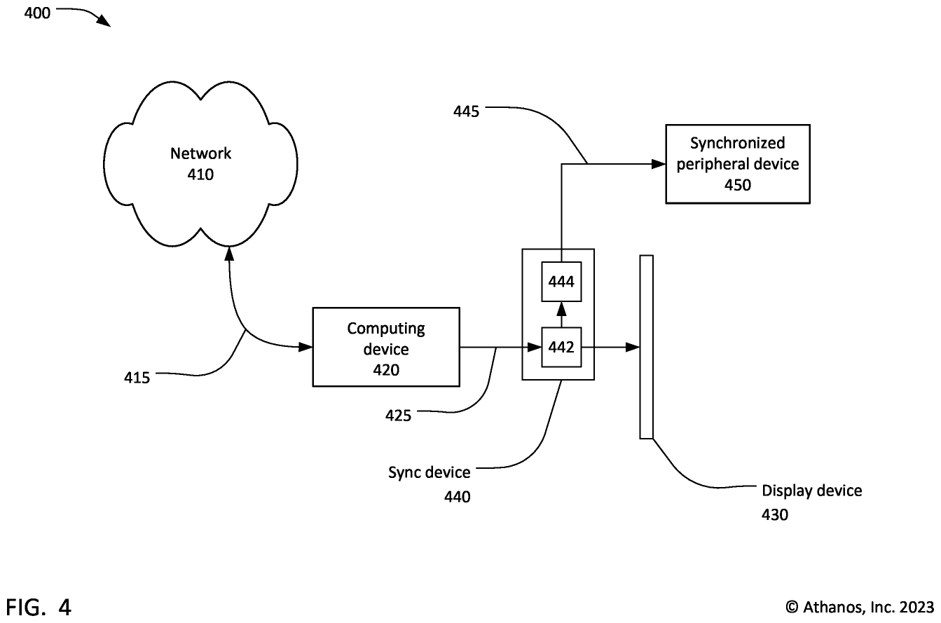

Referring now to FIG. 4, a system 400 includes a computing device 420, a display device 430, a sync device 440, and a synchronized peripheral device 450. The computing device 420 may typically, but not necessarily, be connected to a network 410. The sync device 400 includes a data extractor 442 and a synchronization signal generator 444. The network 410, the computing device 420, the display device 430, the synchronization signal generator 444, and the synchronized peripheral device 450 are essentially the same as the counterpart elements of the system 100 of FIG. 1. Descriptions of these elements will not be repeated.

The data extractor 442 is connected to the communication link 425 between the computing device 420 and the display device 430. The data extractor 442 receives the display image frame data from the computing device 420 and extracts synchronization data directly from the display image frame data (as opposed to the data extractor 142 of the system 100, which extracts the synchronization data from the image on the display device). To this end, the data extractor 442 includes a processor or other logic circuitry to locate the synchronization data within the display image frame data. The synchronization data may be extracted before, or concurrently with, the images frames being displayed on the display device 430. Extracting the synchronization data directly from the display image frame data may reduce the number of pixels used to embed the synchronization data. For example, shutter glasses for viewing stereographic images could be synchronized using a single pixel to indicate a frame was intended for the viewer's left or right eyes.

Since image frame data commonly has 24 bits of data for each display pixel, the data for a single pixel could be used synchronize peripheral devices that are substantially more complex than shutter glass. For example, the data for a single pixel could provide synchronized binary (e.g. on/off) commands to 24 different peripheral device functions or could control both the amplitude and frequency of a sound effect or a haptic such as seat vibration.

Where appropriate, the data for multiple display pixels could be used to upload operating parameters and other data to peripheral device(s) synchronous with display image frames. For example, the data for the first row of pixels could be used to deliver nearly 8 kilobytes of synchronization data each image frame, at a cost of losing about 0.05% of the display image area.

The image frame data for a large number of pixels, possibly encompassing one or more image frames, could be used to upload data and/or firmware to initialize one or more peripheral devices. Such an initialization upload would not be performed every image frames but may be performed, for example, once at the beginning of an operating session.

When the synchronization data is extracted from the display image data, the sync device 440 is agnostic to the type of display 430 but must be cognizant of, and adapted to, the image data transmission protocol for the display image data. The sync device 440 may be physically separate from the display device 430 or may be integrated into the display device.

Description of Processes

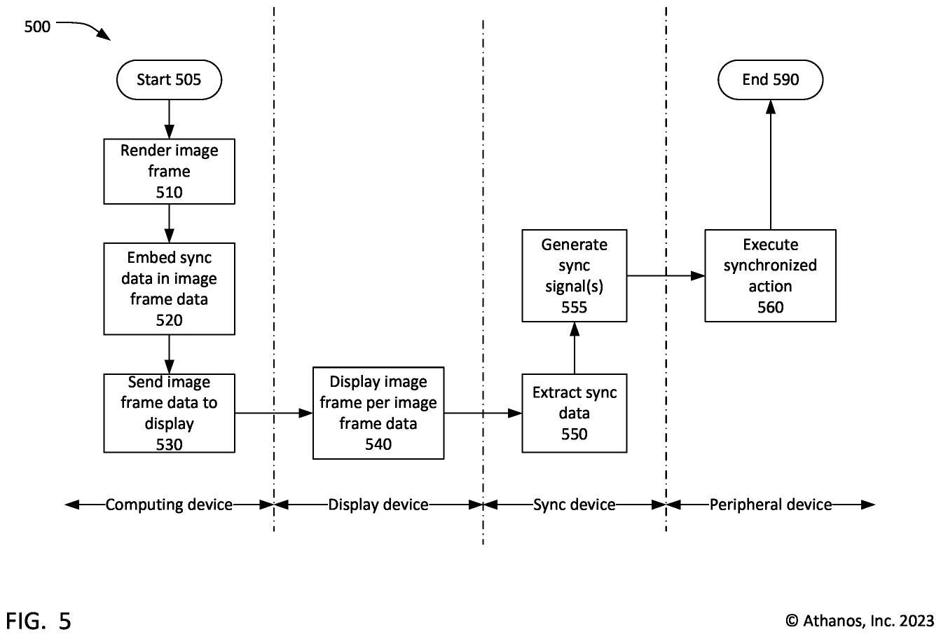

FIG. 5 is a flowchart of a process 500 for synchronizing a peripheral device with a display image frame. The process 500 starts at 505, ends at 590, and only includes actions to generate and display a single display image frame. To provide a continuous sequence of display image frames at a target frame rate, two or more instantiations of the process 500 can run concurrently. The process 500 is performed by a computing device which may be the computing device 120, a display device which may be the display device 130, a sync device which may be the sync device 140, and a synchronized device which may be the peripheral synchronized device 150.

At 510, the computing device renders a display image frame by determining the appropriate color value of each pixel of the display image frame and storing the color values as image frame data. Typically, the image frame data is stored in a frame buffer portion of the computing device memory. Memory addresses within the frame buffer map to corresponding pixels with the display image frame. While rendering the display image frame, the computing device stores a color value for each pixel at the corresponding addresses within the frame buffer. Typically, each display pixel has red, green, and blue sub-pixels. The color value of each pixel is represented by an eight-bit value for each of the three subpixels which allows nearly 17 million different color values for each pixel. The computing device may have multiple frame buffers available such that a first instantiation of the process 500 may render an image frame a first frame buffer while a previous instantiation of the process 500 reads from a second frame buffer to send image frame data to the display.

At 520, synchronization data is embedded within the image frame data of each display frame by writing one of a predetermined set of color values to memory addresses corresponding to a predetermined set of display pixels. The predetermined set of color values is selected from the possible range of color values. The predetermined set of color values may contain as few as two values (e.g. black and white) and typically will not contain more than ten color values. The predetermined set of pixels may be divided into two or more subsets or pixels, each of which may receive a different color value.

Synchronization data may be embedded within the display image data in the frame buffer after the rendering of a display image frame is complete by replacing the display image data for a predetermined pixel set with the synchronization data. Alternatively, the computing device 120 may generate the display image data and the synchronization data concurrently.

At 530, image frame data, including the embedded synchronization data, is read from the frame buffer and transmitted to the device. While the image frame data is being sent to the display, a subsequent instantiation of the process 500 may render a subsequent image frame using a different frame buffer. At 540, the display device displays the image frame in accordance with the image frame data received from the computing device.

At 550, the sync device extracts the synchronization data for the display image frame by optically sensing the color value or values of the predetermined pixel set as displayed on the display device. At 555, the sync device generates one or more synchronization signals based on the synchronization data extracted at 550. The synchronized device executes some action at 560 in response to the synchronization signals. Generating the synchronization signal(s) based on data extracted from the displayed image ensures the synchronization signal(s) and the actions of the synchronized device are precisely synchronized with each sequential display image frame. Generating the synchronization signal(s) based on data extracted from the displayed image also makes the process 500 agnostic with respect to the type of the display device and to the protocol used to transmit the image from data from the computing device to the display device.

Thereafter, the process 500 ends at 590. As previously described, subsequent instantiations of the process 500 run continuously and commonly in parallel to generate a continuous sequent of display image frames with corresponding synchronization data.

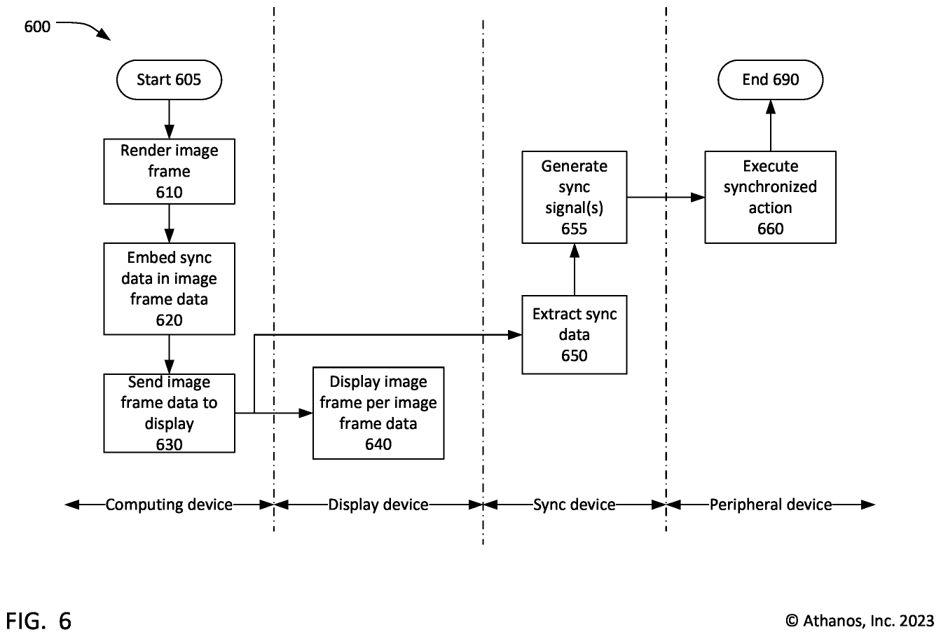

FIG. 6 is a flowchart of another process 600 for synchronizing a peripheral device with a display image frame. The process 600 starts at 605, ends at 690, and only includes actions to generate and display a single display image frame. To provide a continuous sequence of display image frames at a target frame rate, two or more instantiations of the process 600 can run concurrently. The process 600 is performed by a computing device which may be the computing device 420, a display device which may be the display device 430, a sync device which may be the sync device 440, and a synchronized device which may be the peripheral synchronized device 450.

The actions 610, 620, 630, 640, 655, and 660 in the process 600 are generally the same as the counterpart actions 510, 520, 530, 540, 555, and 560 in the process 500 of FIG. 5. Descriptions of these actions will not be repeated.

The primary difference between the processes 500 and 600 is that, at 650, the synchronization data is extracted from the image frame data transmitted by the computing device ((as opposed to being extracted from the image frame displayed on the display device. To extract the synchronization data from the image frame data requires locating the predetermined pixel set within the image frame data and determining the color value(s) assigned to the predetermined pixels set. Extracting the synchronization data directly from the image frame data may reduce the number of pixels needed to convey the synchronization data and may facilitate embedding complex synchronization data (since a single pixel may have nearly 17 million different color values). However, the technique used to extract the synchronization data from the image frame data is specific to the protocol used to transmit the image frame data from the computing device to the display device.

In both the processes 500 and 600, embedding the synchronization in the image frame data is accomplished by executing an application software program. The processes 500 and 600 do not require any specific hardware to generate or transmit synchronization data or signals and are thus compatible with existing computing devices. In both the processes 500 and 600, the sync device may be physically separate from the display device or may be integrated into the display device.

Closing Comments

Throughout this description, the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method of synchronizing a peripheral device with display image frames, comprising:
generating image frame data for a sequence of display image frames, the image frame data comprising color values for a plurality of display picture elements (pixels);
embedding synchronization data in a predetermined set of pixels within the image frame data of each of the sequence of image frames, and
transmitting the image frame data, including the synchronization data, to a display device.

2. The method of claim 1, wherein embedding synchronization data comprises:
setting a color value of the predetermined set of pixels to one of a predetermined set of color values.

3. The method of claim 2, wherein
the peripheral device is shutter glasses, and
the predetermined set of color values comprises a first color value indicating a display image frame is intended for a viewer's right eye and a second color value indicating a display image frame is intended for a viewer's left eye.

4. The method of claim 1, further comprising:
extracting the synchronization data from the image frame data transmitted to the display device.

5. The method of claim 4, further comprising:
generating a synchronization signal based on the synchronization data extracted from the image frame data; and
transmitting the synchronization signal to the peripheral device, wherein the peripheral device performs an action synchronized with the display image frame in response to the synchronization signal.

6. The method of claim 4, wherein extracting the synchronization data comprises:
optically sensing a color value of the predetermined pixel set displayed on the display device.

7. The method of claim 4, wherein extracting the synchronization data comprises:
determining a color value of the predetermined pixel set from the image frame data transmitted to the display device.

8. A computer-readable medium storing instructions that, when executed by a computing device, causes the computing device to perform actions comprising:
generating image frame data for a sequence of display image frames, the image frame data comprising color values for a plurality of display picture elements (pixels);
embedding synchronization data in a predetermined set of pixels within the image frame data of each of the sequence of image frames; and
transmitting the image frame data, including the synchronization data, to a display device.

9. The computer-readable medium of claim 8, wherein embedding synchronization data comprises:
setting a color value of the predetermined set of pixels to one of a predetermined set of color values.

10. The computer-readable medium of claim 9, wherein
the predetermined set of color values comprises a first color value indicating a display image frame is intended for a viewer's right eye and a second color value indicating a display image frame is intended for a viewer's left eye.

11. A system for synchronizing a peripheral device with display image frames, comprising:
a computing device configured to:
generate image frame data for a sequence of display image frames, the image frame data comprising color values for a plurality of display picture elements (pixels);
embed synchronization data in a predetermined set of pixels within the image frame data of each of the sequence of image frames, and
transmit the image frame data, including the synchronization data, to a display device;
a data extractor to extract the synchronization data from the image frame data transmitted to the display device; and
a synchronization signal generator to:
generate at least one synchronization signal based on the extracted synchronization data, and
transmit the synchronization signal to the peripheral device, wherein the peripheral device performs an action synchronized with the display image frame in response to the synchronization signal.

12. The system of claim 11, wherein the synchronization data is embedded by setting a color value of the predetermined set of pixels to one of a predetermined set of color values.

13. The system of claim 12, wherein
The peripheral device is shutter glasses, and
the predetermined set of color values comprises a first color value indicating a display image frame is intended for a viewer's right eye and a second color value indicating a display image frame is intended for a viewer's left eye.

14. The system of claim 11, wherein the data extractor comprises:
at least one optical sensor to sense a color value of the predetermined pixel set displayed on the display device.

15. The system of claim 11, wherein the data extractor comprises:
digital circuitry to extract a color value of the predetermined pixel set from the image frame data transmitted to the display device.

16. An apparatus to synchronize a peripheral device with display image frames, wherein each display frame comprises a plurality of pixels and synchronization data is embedded in a predetermined set of pixels from the plurality of pixels, the apparatus comprising:
a data extractor to extract the synchronization data from the display image frames; and
a synchronization signal generator to generate at least one synchronization signal based on the extracted synchronization data.

17. The apparatus of claim 16, wherein the data extractor comprises:
at least one optical sensor to sense a color value of the predetermined pixel set displayed on the display device.

18. The apparatus of claim 16, wherein the data extractor comprises:
digital circuitry to extract a color value of the predetermined pixel set from image frame data received by the display device.
